(19) United States
(12) Patent Application Publication
(10) Pub. No.: US 2018/0037310 A1
(43) Pub. Date: Feb. 8, 2018

(54) HYDRAULIC SYSTEM

(71) Applicant: BAE SYSTEMS plc, London (GB)

(72) Inventor: PETER MATTHEW LANGLEY, Caythorpe Lincolnshire (GB)

(73) Assignee: BAE SYSTEMS plc, London (GB)

(21) Appl. No.: 15/555,345

(22) PCT Filed: Mar. 3, 2016
(86) PCT No.: PCT/GB2016/050560

§ 371 Date: Sep. 1, 2017

(30) Foreign Application Priority Data
Mar. 13, 2015 (EP) 15275064.2
Mar. 13, 2015 (GB) 1504270.8

(51) Int. Cl. B63H 25/12; B63G 8/14; B62D 5/06; B63H 25/22

(52) U.S. Cl. CPC B63H 25/12; B63H 25/22; B63G 8/14; B62D 5/063; F15B 15/222

(57) ABSTRACT

A hydraulic system for supplying fluid to an actuator comprising a variable speed prime mover drivingly coupled to a variable displacement hydraulic pump. The system is configured to deliver hydraulic fluid via fluid conduits to an actuator. It may deliver hydraulic fluid to an actuator at a first hydraulic pressure at a first rate of pressure rise; and at a second hydraulic pressure at a second rate of pressure rise. The first hydraulic pressure may be greater than the second hydraulic pressure; and the first hydraulic rate of pressure rise may be lower than the second hydraulic rate of pressure rise.

The present disclosure relates to a hydraulic system.

In particular the disclosure is concerned with a hydraulic system for supplying fluid to an actuator.

### BACKGROUND

Surface ships and submarines have moveable control surfaces, for example rudders, which are moved in order to control the direction of the vessel.

Conventionally the control surfaces may be coupled to, and moved by, actuators powered by systems of hydraulic power units and control valves. Each hydraulic power unit may supply several actuators. This means the system may be spread over a large area of the vessel and comprise of complex pipework, interfaces and valve systems that are time consuming to install, difficult to flush and must be monitored and maintained.

Additionally the performance requirements of conventional actuation systems are generally specified to meet requirements of maximum anticipated load/force and maximum slew rate (i.e. rate of change of displacement of the control surface). Hence the geometry of the actuator is configured to achieve the maximum anticipated load, which in turn sets the oil flow rate to achieve the required slew rate.

However, the ability to produce simultaneous high force and high rate of change of displacement are not necessary to achieve most operational requirements. Hence such configurations are over specified for their functionality they need to provide, which introduces size, efficiency and weight penalties on the system as a whole, and hence the vessel in which they are included.

Hence a hydraulic system configured to deliver optimum force and displacement requirements to a control surface via an actuator, and which may also be conveniently packaged in a vessel, is highly desirable.

### SUMMARY

According to the present disclosure there is provided an apparatus and method as set forth in the appended claims. Other features of the invention will be apparent from the dependent claims, and the description which follows.

Accordingly there may be provided a hydraulic system for supplying fluid to an actuator comprising: a variable speed prime mover drivingly coupled to a variable displacement hydraulic pump; the system configured to deliver hydraulic fluid via fluid conduits to an actuator: at a first hydraulic pressure at a first rate of pressure rise; and at a second hydraulic pressure at a second rate of pressure rise; the first hydraulic pressure being greater than the second hydraulic pressure; and the first hydraulic rate of pressure rise being lower than the second hydraulic rate of pressure rise.

The system may be operable to deliver: a range of values of first hydraulic pressure and second hydraulic pressure the range of values of the first hydraulic pressure being greater than the range of values of second hydraulic pressure; and a range of values of first hydraulic rate of pressure rise and second hydraulic rate of pressure rise the range of values of the first hydraulic rate of pressure rise being lower than the range of values of the second hydraulic rate of pressure rise.

The variable displacement hydraulic pump may have at least two ports, each port for the delivery and receipt of fluid from the fluid conduits.

The prime mover may comprise an electric motor controllable by, and in signal communication with, a variable speed motor drive operable to drive the electric motor to have a variable output.

The system may further comprise: a boost pump in fluid communication with the variable displacement hydraulic pump; the boost pump operable to supply hydraulic fluid to the variable displacement hydraulic pump for actuation of the variable displacement hydraulic pump; and a controller to regulate the supply of hydraulic fluid to thereby regulate the output of the variable displacement hydraulic pump.

The boost pump may be coupled to the variable speed prime mover via the variable displacement hydraulic pump.

The variable displacement hydraulic pump may be drivingly coupled to the variable speed prime mover via the boost pump.

The boost pump may be drivingly coupled to a further prime mover, the further prime mover being different to the variable speed prime mover drivingly coupled to the variable displacement hydraulic pump.

There may also be provided a hydraulic actuator system comprising: a hydraulic system according to the present disclosure in fluid communication with an actuator, the actuator provided with a displacement member for coupling to an element operable to be displaced; the hydraulics system being operable to supply fluid to the actuator to provide: a first force at a first rate of change of displacement of the displacement member; and a second force at a second rate of change of displacement of the displacement member; the first force being greater than the second force; and the first rate of change of displacement being lower than the second rate of change of displacement.

The actuator may be operable to deliver a range of values of first force and second force, the range of values of the first force being greater than the range of values of second force; and a range of values of first rate of change of displacement and second rate of change of displacement, the range of values of the first rate of change of displacement being lower than the range of values of second rate of change of displacement.

The hydraulic system may be in fluid communication with only one actuator.

There may also be provided a vessel comprising a moveable control surface coupled to a hydraulic actuator system according to the present disclosure.

There may also be provided a method of operating a hydraulic system, the hydraulic system comprising a variable speed prime mover drivingly coupled to a variable displacement hydraulic pump; the method comprising the step of: controlling output of the variable pump and the output of the prime mover to thereby control the pressure and rate of pressure rise of fluid pumped by the system for delivery to an actuator.

The method may comprise the steps of delivering fluid: at a first hydraulic pressure at a first rate of pressure rise to an actuator; and at a second hydraulic pressure at a second rate of pressure rise to the actuator; the first hydraulic pressure being greater than the second hydraulic pressure; and the first hydraulic rate of pressure rise being lower than the second hydraulic rate of pressure rise.

The variable pump and the prime mover may be operable to be controlled such that: the displacement of the variable pump is fixed and the output of the prime mover is variable; or the displacement of the variable pump is variable and the output of the prime mover is fixed; or the displacement of the variable pump is variable and the output of the prime mover is variable.

There may also be provided a method of operating a hydraulic system according to the present disclosure wherein: the method further comprises the step of determining instantaneous power usage of the system in dependence upon at least two of: prime mover output speed; variable pump displacement; variable pump flow rate; fluid pressure; actuator load; and actuator rate of change of displacement; the method further comprising the step of varying: prime mover output speed; or variable pump displacement such that the value of determined instantaneous power usage does not exceed a pre-determined limit.

There may also be provided a method of operating a vessel the vessel comprising a control surface coupled to a hydraulic actuator system according to the present disclosure comprising the method of operating a hydraulic system according to the present disclosure.

Each actuator has a dedicated hydraulic power unit capable of high fluid flow rate at low fluid pressure, or low fluid flow rate at high fluid pressure. This arrangement may be termed a “variable pressure hydraulic system” because the pressure generated at the pump is directly related to the load on the actuator.

That is to say, there is provided a Variable Pressure Hydraulic (VPH) system which enables positional control of a control surface coupled to an actuator, and which is operable to be powered by a hydraulic system of the present disclosure.

### BRIEF DESCRIPTION OF THE DRAWINGS

Examples of the present disclosure will now be described with reference to the accompanying drawings, in which:

FIG. 1 shows a vessel comprising a control surface moveable by a hydraulic system according to the present disclosure;

FIG. 2 shows a first example of a hydraulic actuator system according to the present disclosure;

FIG. 3 shows a second example of a hydraulic actuator system according to the present disclosure; and

FIG. 4 shows a third example of a hydraulic actuator system according to the present disclosure.

### DETAILED DESCRIPTION

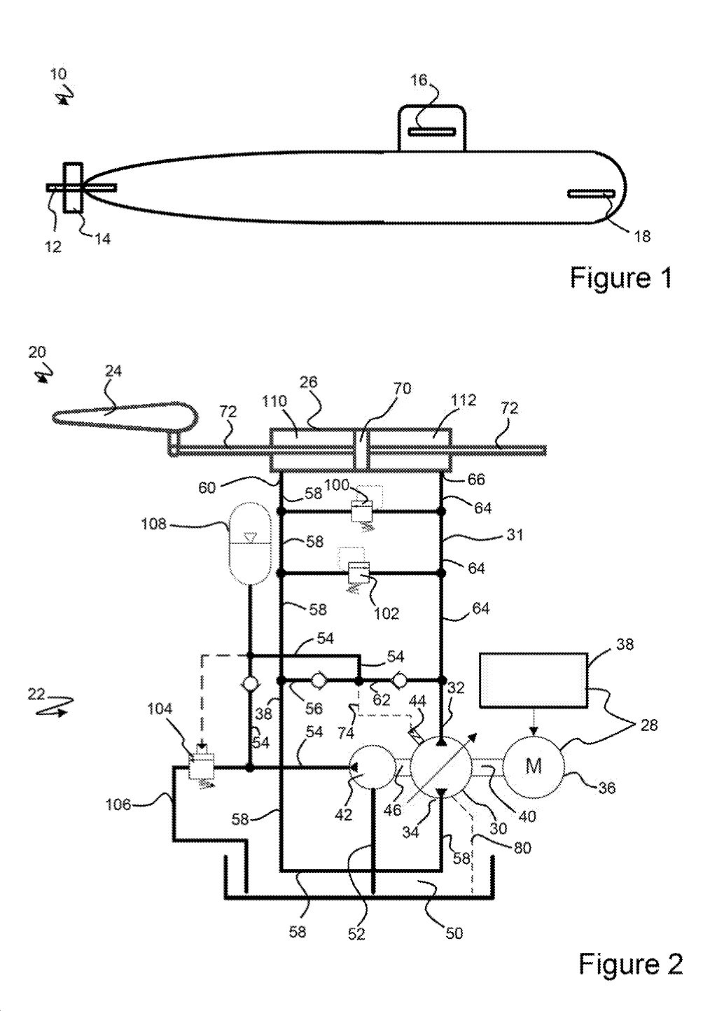

FIG. 1 shows a side view of a submersible water vessel 10. The vessel 10 includes a number of control surfaces, for example stern planes 12, rudder planes 14, sail vanes 16 and/or hydroplanes 18. Movement of these control surfaces enables directional control of the vessel 10. Each of the control surfaces 12, 14, 16, 18 may be coupled to an actuator which is in fluid communication with a hydraulic system according to the present disclosure.

FIG. 2 shows a first example of a hydraulic actuator system 20 which comprises a hydraulic system 22 according to the present disclosure. A control surface 24, which may be any control surface of a vessel, is coupled to a hydraulic actuator 26. That is to say, the hydraulic system 22 is in fluid communication with only one actuator 26, and the actuator 26 is in communication with only one control surface 24.

The hydraulic system 22, configured for supplying fluid to the actuator 26, comprises a variable speed prime mover 28 drivingly coupled to a variable displacement hydraulic pump 30. The hydraulic system 22 is configured to deliver hydraulic fluid to fluid conduits 31, which are shown in FIG. 2 as thick black lines forming fluid passageways throughout the hydraulic system 22. The fluid conduits are made up of a number of fluid lines, as described below. The variable displacement hydraulic pump 30 has at least two ports 32, 34, each port 32, 34 for the delivery and receipt of fluid from the fluid conduits 31.

The prime mover 28 may comprise an electric motor 36 controllable by, and in signal communication with, a variable speed motor drive 38. The variable speed motor drive 38 is operable to drive the electric motor 36 to have a variable output. In other examples, the prime mover may instead comprise any suitable variable speed prime mover, such as an air motor, engine or hydraulic motor.

The prime mover 28 is coupled to, and driven by, the variable displacement pump 30 via a shaft 40. Hence the prime mover 28 is operable to produce a rotational output which is communicated to the variable displacement pump 30 by the shaft 40.

The system 22 further includes a boost pump 42 in fluid communication with the variable displacement hydraulic pump 30 for actuation of the variable displacement hydraulic pump 30. A controller 44 is provided in the fluid conduit between the boost pump 42 and the variable displacement hydraulic pump 30. The controller 44 is operable to regulate the supply of hydraulic fluid to the variable displacement pump 30 to thereby regulate the output of the variable displacement hydraulic pump 30.

In the example shown in FIG. 2, the boost pump 42 is coupled to the variable speed prime mover 28 via the variable displacement hydraulic pump 30. A shaft 46 couples the boost pump 42 to an output from the variable displacement pump 30. In one example the shaft 46 may be directly coupled to the shaft 40 which extends between the prime mover 28 and the variable displacement pump 30. In another example the shaft 46 may be indirectly coupled to the shaft 40 which extends between the prime mover 28 and the variable displacement pump 30. Hence the prime mover 28 may directly or indirectly drive the boost pump 42.

The boost pump 42 is in fluid communication with a fluid reservoir 50 via a conduit 52. A fluid line 80 extends between the variable displacement pump 30 and the fluid reservoir 50 to allow for flow from the variable displacement pump 30 casing to the reservoir 50 as required. The boost pump 42 is also in fluid communication with the fluid conduits 31 which extend between the variable displacement pump 30 and the actuator 26.

The boost pump 42 is in fluid communication with the fluid conduits 31 via a fluid line 54. Additionally a fluid line 74 extends between the fluid line 54 and the variable displacement pump 30 via the controller 44. Hence the boost pump delivers hydraulic fluid to the flow conduits 31 via the fluid line 54, and delivers hydraulic fluid to adjust the variable displacement pump 30 output via the fluid line 74. That is to say, the boost pump 42 is operable to provide oil to maintain a minimum pressure in, and flushing flow to, the pipework connected to the actuator 26, and provide a pilot supply needed to vary the displacement of the variable displacement pump 30. For example, the pump 30 may comprise a swash plate, the orientation of which may be adjusted by delivery of pressurised fluid via the fluid line 74 from the boost pump 42, thereby adjusting the output of the variable displacement pump 30, as is well known in the art.

Variable displacement hydraulic pumps are usually optimised for either clockwise or anticlockwise rotation of the shaft. Pumps designed for open hydraulic circuits can vary flow in the region 0% to 100%. However, pumps designed for closed hydraulic circuits, such as those of the present disclosure, can vary flow in the range −100% to 100%. That is to say, they are configured to deliver bidirectional flow with unidirectional shaft rotation. This is achieved by swiveling the swash plate control about a zero “null” position (i.e. “over centre”).

Thus the pump 30 is rotatable in only one direction (i.e. it is uni-directional) but the direction of fluid flow supplied to the actuator (i.e. whether to port 60 or port 66) may be varied by changing the position of the over-centre swashplate (i.e. swiveling the swash plate control about the zero “null” position).

Thus the pump 30 is bi-directional, in that it can deliver flow in two directions, even though it is rotatable in only one direction.

Fluid line 56 fluidly connects fluid line 54 to a fluid line 58 which extends between port 34 of the variable displacement pump 30 and a port 60 provided in the housing of the actuator 26. A fluid line 62 fluidly connects the fluid line 54 to a fluid line 64 which extends between port 32 of the variable displacement pump 30 and a port 66 in the housing of the actuator 26. The actuator 26 comprises a piston (or displacement member) 70 which is slideable within the housing of the actuator 26. The displacement member 70 further comprises a rod 72 which is coupled to the control surface 24. The precise nature of the coupling is not described here in detail, and does not form part of the present invention. Suffice it to say that the coupling is such that displacement of the rod 72 may be translated into a displacement of the control surface 24 in a desired direction.

The system further comprises a number of pressure control valves common to hydraulic systems, which protect the hydraulic system in case of overloading of the actuator 26. For example, a first pressure relief valve 100 is provided between fluid line 58 and 64, allowing flow in one direction, and a second pressure relief valve 102 is provided between the fluid lines 58 and 64 allowing fluid flow in the opposite direction. There is also provided a fluid control unloader valve 104 (i.e. pressure release valve) in flow communication with line 54. A fluid line 106 extends from the unloader valve 104 to the reservoir 50, operable to allow fluid to be exhausted to the reservoir 50 when a set pressure in fluid line 54 is reached. That is to say, when a predetermined pressure in line 54 is reached, the unloader valve 104 opens to permit flow of fluid to the reservoir 50. When the pressure drops in line 54 to a lower predetermined pressure, the unloader valve 104 may be operable to close, stopping the flow of fluid to the reservoir 50.

An accumulator 108 is provided in fluid communication with the fluid line 54 in order to provide a source of pressurised fluid to the system that supplements the boost pump 42 supply flow, thereby maintaining a baseline pressure in the conduits 31 and fluid line 74.

In the example shown in FIG. 2, the prime mover 28 is operable to drive the variable displacement pump 30 and the boost pump 42 at various speeds, determined by operational load requirements of the control surface 24. The variable displacement pump 30 draws hydraulic fluid from one side of the actuator 26 and delivers it to the other side of the actuator 26 at various flow rates. The flow supplied to the actuator 26 may be at the minimum load dependant pressure required to move the displacement member 70 against the required operating load of the control surface 24.

The velocity of the displacement member 70 can be varied by changing the displacement of the variable displacement pump 30 or by varying the speed of the prime mover 28, or through a combination of the two options.

Thus, in operation, the prime mover 28 will turn the variable displacement pump 30, the output of the pump 30 being controlled by the controller 44, and fluid may be delivered to a left hand chamber 110 of the actuator 26 (as shown in FIG. 2) via the port 60 and fluid line 58. This biases the displacement member 70 towards the right (as viewed in FIG. 2). At the same time, fluid present in the right hand chamber 112 of the actuator 26 is exhausted through the port 66 into fluid line 64 back to the variable displacement pump 30.

Conversely, fluid may be delivered from the variable displacement pump 30 to the actuator 26 via the port 66 to the right hand chamber 112 of the actuator 26 to force the displacement member 70 to the left (as viewed in FIG. 2). Fluid in the left hand chamber 110 of the actuator 26 will be transported back to the variable displacement pump 30 via the fluid line 58.

The output of the variable pump 30 and the output of the prime mover 28 are controlled to thereby control the pressure and rate of pressure rise of fluid pumped by the variable displacement pump 30 for delivery to the actuator 26. Since the output of both the prime mover 28 and variable displacement pump 30 are variable, both the pressure of the fluid and the rate of pressure rise of the fluid being delivered to the actuator 26 may be varied, a nominally high value of one of pressure or rate of pressure rise resulting in a nominally low value of the other.

Thus the prime mover 28 and variable displacement pump 30 are controlled, and hence operable, to deliver hydraulic fluid via the flow conduits and flow lines, at a first hydraulic pressure at a first rate of pressure rise to the actuator 26. The prime mover 28 and the variable displacement pump 30 may also be controlled, and hence be operable, to deliver fluid to the actuator 26 at a second hydraulic pressure at a second rate of pressure rise to the actuator 26. Further, the prime mover 28 and the variable displacement pump 30 are operable to deliver the hydraulic fluid to the actuator 26 such that the first hydraulic pressure is greater than the second hydraulic pressure, or the first hydraulic rate of pressure rise is lower than the second hydraulic rate of pressure rise.

The system is operable to deliver a range of values of first hydraulic pressure and second hydraulic pressure, the range of values of the first hydraulic pressure being greater than the range of values of second hydraulic pressure.

The system is also operable to deliver the range of values of first hydraulic rate of pressure rise and second hydraulic rate of pressure rise, the range of values of the first hydraulic rate of pressure rise being lower than the range of values of the second hydraulic rate of pressure rise.

In practice this means that fluid entering the chambers 110, 112 of the actuator 26, having a given pressure, will induce a force on the displacement member 70. This force is then transmitted to the control surface 24 via the rod and coupling 72.

The rate of pressure rise of the hydraulic fluid in the chambers 110, 112 of the actuator 26 will govern the rate of change of displacement (i.e. speed) of the displacement member 70. Movement of the displacement member 70 in response to the rate of pressure rise will be translated by the rod 72 and coupling to the control surface 24 and thus control the speed of rotation of the control surface 24.

That is to say, the hydraulics system 22 is operable to supply fluid to the actuator 26 to provide a first force at a first rate of change of displacement of the displacement member 70, and a second force at a second rate of change of displacement of the displacement member 70.

The prime mover 28 and the variable displacement pump 30 are configured, controlled, and operable, such that the fluid delivered to the actuator 26 results in the first force being greater than the second force, and the first rate of change of displacement is lower than the second rate of change of displacement. Put another way, the hydraulic actuator system of the present disclosure allows for the displacement member 70 to deliver a nominally high force at a nominally low rate of change of displacement, or a nominally low force at a nominally high rate of change of displacement.

Thus the actuator 26 is operable to deliver a range of force values, for example a first force and second force, or a first range of values of forces and a second range of values forces, the first range of values of forces being greater than the second range of values of forces. It is also thus operable to deliver a range of values of first rate of change of displacement and second rate of change of displacement, the range of values of the first rate of change of displacement being lower than the range of values of second rate of change of displacement.

The value of hydraulic fluid pressure generated by the pump 30 is chosen (for example by an operator and/or vessel control system) to counter and overcome hydrodynamic load on the control surface 24 that continually varies with vessel speed, control surface deflection and water density.

That is to say, the actuator is operable to deliver a range of force values and a range of rates of displacement to accommodate the load and speed requirements of the control surface 24. However, the range of forces which are nominally high, are all greater than the range of forces which are nominally low. Likewise, the range of values of displacement which are all nominally low are all lower than the range of rates of displacement which are nominally high.

For example, the first (nominally high) range of forces may be about ten times greater than the second (nominally low) range of forces. The first (nominally low) rate of change of displacement may be about ten times lower than the second (nominally high) rate of change of displacement.

Alternatively, the first (nominally high) range of forces may be at least five times, but no more than ten times greater than the second (nominally low) range of forces. The first (nominally low) rate of change of displacement may be at least five times, but no more than ten times greater than the second (nominally high) rate of change of displacement.

Additionally, the variable pump 30 and the prime mover 28 are operable to be controlled in three modes of operation, described below assuming a constant load on the control surface/actuator.

In a first mode, the displacement of the variable pump 30 may be fixed whilst the output of the prime mover 28 is varied.

In a second mode, the displacement of the variable pump 30 may be varied whilst the output of the prime mover 28 is fixed.

In a third mode, the displacement of the variable pump 30 may be varied whilst the output of the prime mover 28 is also varied.

These three modes give a versatility of output of fluid pressure, rate of change of fluid pressure, and hence output force and rate of change of actuator displacement not available to arrangements of the related art.

In order to ensure efficiency of the system, the system may be controlled by determining the instantaneous power usage of the system. This may be determined in dependence upon at least two of prime mover output speed, variable pump displacement; variable pump flow rate, fluid pressure, actuator load, and actuator speed (i.e. rate of change of displacement). The prime mover output speed and/or variable pump displacement may be varied such that the value of determined instantaneous power usage does not exceed a predetermined limit, thereby ensuring efficiency and predictability of the power usage of a system according to the present invention.

The actuator load may be determined directly (e.g. strain gauge) or indirectly by measuring the pressure in the actuator chambers 110,112 and then determining the force in dependence of the pressure differential between the chambers 110,112.

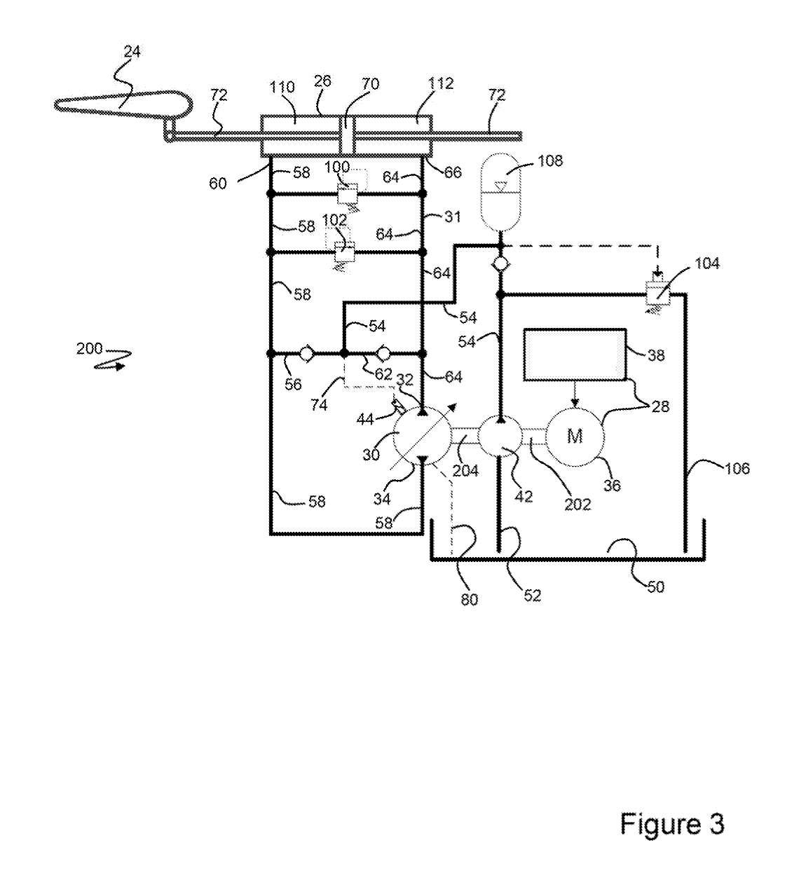

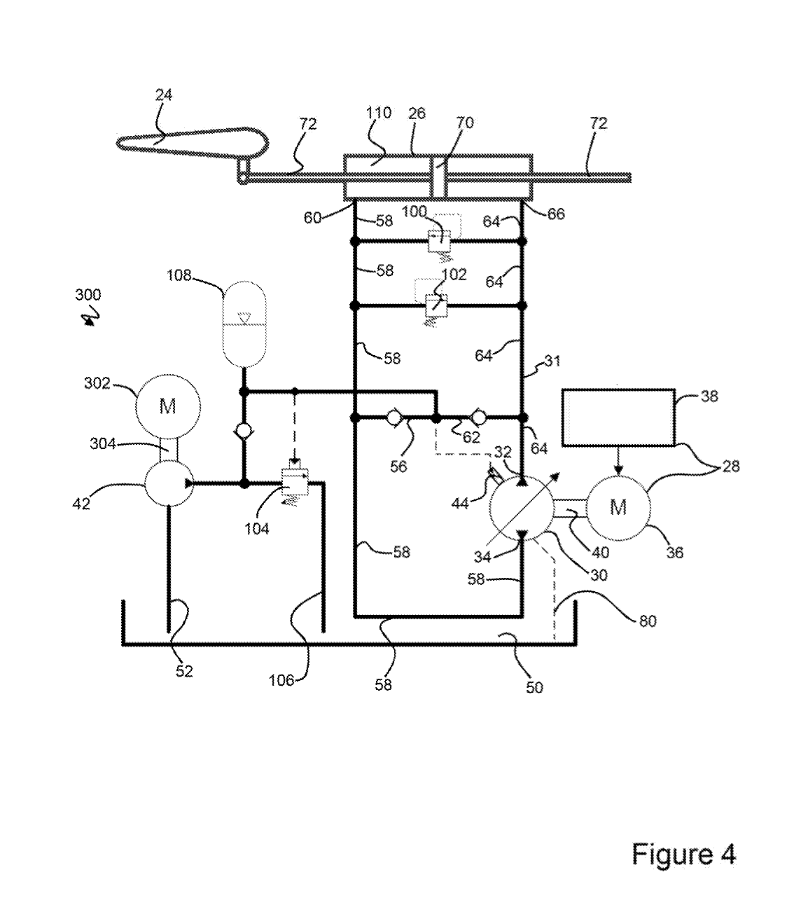

FIG. 3 and FIG. 4 show alternative hydraulic systems 200, 300 to that shown in FIG. 2. In most respects they are the same as the configuration shown in FIG. 2, and like components are identified using common reference numerals.

The only difference between the system 200 shown in FIG. 3 and the system 22 shown in FIG. 2 is that the variable displacement hydraulic pump 30 is drivingly coupled to the variable speed prime mover 28 via the boost pump 42. Hence a shaft 202 extends between the prime mover 28 and the boost pump 42 and a shaft 204 extends between the boost pump 30 and the variable displacement pump 42. In one example the shaft 202 and shaft 204 may be directly coupled to one another. In another example the shaft 202 and shaft 204 may be indirectly coupled to one another. As in the preceding example, the prime mover 28 provides an output which powers both the boost pump 42 and the variable displacement pump 30.

FIG. 4 shows a hydraulic system 300 according to the present disclosure. The only difference between the example shown in FIG. 4 and the examples of FIGS. 2 and 3 are that instead of the boost pump 42 being driven by the prime mover, it is driven by a different prime mover 302. That is to say a prime mover 302 is drivingly coupled to the boost pump 42 via a shaft 304. Put another way, the boost pump 42 is drivingly coupled to a further prime mover 302, the further prime mover 302 being different to the variable speed prime mover 28 drivingly coupled to the variable displacement hydraulic pump 30.

In all other respects, and modes of operation, the hydraulic systems 200, 300 shown in FIGS. 3 and 4 are identical to that of hydraulic system 22 shown in FIG. 2.

The systems and methods of the present disclosure have been described with reference to a submersible water vessel 10. However, they are equally applicable to a surface vessel. For example, a surface vessel may have a rudder or other control surface coupled to, and operable to be moved by, a hydraulic system according to the present disclosure.

Since only combinations of high force and low rates of displacement, or low force and high rates of displacement, are required, the actuator, pump and prime mover do not need to be as highly rated (i.e. as large) as in systems of a conventional kind.

The arrangement of the system of the present disclosure is modular, requires less interaction with other systems on the vessel, and can thus be relatively compact compared to a system of the related art. This is obviously an advantage for any arrangement, but especially those in a vessel where space is limited.

Also, a variable displacement hydraulic pump is inherently efficient. By setting the swash plate control to zero displacement, driving shaft torque will approach zero and demand on the prime mover falls accordingly. If there is a preference to run the motor at an optimum constant speed, and vary the flow mainly with swash plate control, it is possible to use the pump's swash control over its entire range from −100% to +100%. Hence the prime movers performance can be optimised for the speed it may run at for long periods of time, thereby increasing overall efficiency of the system.

Thus there is provided a vessel comprising a control surface coupled to a hydraulic actuator system which may be efficiently and accurately controlled, as well as producing only required power and performance output.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A hydraulic system for supplying fluid to an actuator, the system comprising:
a variable speed prime mover drivingly coupled to a variable displacement hydraulic pump;
wherein the system is configured to deliver hydraulic fluid via fluid conduits to an actuator
at a first hydraulic pressure at a first rate of pressure rise; and
at a second hydraulic pressure at a second rate of pressure rise;
the first hydraulic pressure being greater than the second hydraulic pressure; and
the first hydraulic rate of pressure rise being lower than the second hydraulic rate of pressure rise.

2. The hydraulic system of claim 1, wherein the system is operable to deliver:
a range of values of first hydraulic pressure and second hydraulic pressure, the range of values of the first hydraulic pressure being greater than the range of values of second hydraulic pressure; and
a range of values of first hydraulic rate of pressure rise and second hydraulic rate of pressure rise, the range of values of the first hydraulic rate of pressure rise being lower than the range of values of the second hydraulic rate of pressure rise.

3. The hydraulic system of claim 1, wherein the variable displacement hydraulic pump has at least two ports, each port for the delivery and receipt of fluid from fluid conduits.

4. The hydraulic system of claim 1, wherein the prime mover comprises an electric motor controllable by, and in signal communication with, a variable speed motor drive operable to drive the electric motor to have a variable output.

5. The hydraulic system of claim 1, wherein the system further comprises:
a boost pump in fluid communication with the variable displacement hydraulic pump, the boost pump operable to supply hydraulic fluid to the variable displacement hydraulic pump for actuation of the variable displacement hydraulic pump; and
a controller to regulate the supply of hydraulic fluid to thereby regulate the output of the variable displacement hydraulic pump.

6. The hydraulic system of claim 5, wherein:
the boost pump is coupled to the variable speed prime mover via the variable displacement hydraulic pump; or
the variable displacement hydraulic pump is drivingly coupled to the variable speed prime mover via the boost pump; or
the boost pump is drivingly coupled to a further prime mover, the further prime mover being different to the variable speed prime mover drivingly coupled to the variable displacement hydraulic pump.

7. A hydraulic actuator system comprising:
the hydraulic system of claim 1 in fluid communication with an actuator, the actuator provided with a displacement member for coupling to an element operable to be displaced;
the hydraulics system being operable to supply fluid to the actuator to provide
a first force at a first rate of change of displacement of the displacement member; and
a second force at a second rate of change of displacement of the displacement member;
the first force being greater than the second force; and
the first rate of change of displacement being lower than the second rate of change of displacement.

8. The hydraulic actuator system of claim 7, wherein the actuator is operable to deliver:
a range of values of first force and second force, the range of values of the first force being greater than the range of values of second force; and
a range of values of first rate of change of displacement and second rate of change of displacement, the range of values of the first rate of change of displacement being lower than the range of values of second rate of change of displacement.

9. The hydraulic actuator system of claim 7, wherein the hydraulic system is configured to be in fluid communication with only one actuator.

10. A vessel comprising a movable control surface coupled to the hydraulic actuator system of claim 7.

11. A method of operating a hydraulic system, the hydraulic system comprising a variable speed prime mover drivingly coupled to a variable displacement hydraulic pump, the method comprising:
controlling output of the variable pump and the output of the prime mover to thereby control the pressure and rate of pressure rise of fluid pumped by the system for delivery to an actuator.

12. The method of claim 11, further comprising:
delivering fluid at a first hydraulic pressure at a first rate of pressure rise to an actuator; and
delivering fluid at a second hydraulic pressure at a second rate of pressure rise to the actuator;
the first hydraulic pressure being greater than the second hydraulic pressure; and
the first hydraulic rate of pressure rise being lower than the second hydraulic rate of pressure rise.

13. The method of claim 11, wherein the variable pump and the prime mover are operable to be controlled such that:
the displacement of the variable pump is fixed and the output of the prime mover is variable; or
the displacement of the variable pump is variable and the output of the prime mover is fixed; or
the displacement of the variable pump is variable and the output of the prime mover is variable.

14. The method of claim 11, wherein the method further comprises:
determining instantaneous power usage of the system in dependence upon at least two of
prime mover output speed;
variable pump displacement;
variable pump flow rate;
fluid pressure;
actuator load; and
actuator rate of change of displacement; and
varying prime mover output speed or variable pump displacement such that the value of determined instantaneous power usage does not exceed a pre-determined limit.

15. A method of operating a vessel the vessel comprising a control surface coupled to a hydraulic actuator system of claim 7, the method comprising:
controlling output of the variable pump and the output of the prime mover to thereby control the pressure and rate of pressure rise of fluid pumped by the system for delivery to an actuator.

16. The method of claim 15, further comprising:
delivering fluid at a first hydraulic pressure at a first rate of pressure rise to an actuator; and
delivering fluid at a second hydraulic pressure at a second rate of pressure rise to the actuator;
the first hydraulic pressure being greater than the second hydraulic pressure; and
the first hydraulic rate of pressure rise being lower than the second hydraulic rate of pressure rise.

17. The method of claim 15, wherein the variable pump and the prime mover are operable to be controlled such that:
the displacement of the variable pump is fixed and the output of the prime mover is variable; or
the displacement of the variable pump is variable and the output of the prime mover is fixed; or
the displacement of the variable pump is variable and the output of the prime mover is variable.

18. The method of claim 15, wherein the method further comprises:
determining instantaneous power usage of the system in dependence upon at least two of prime mover output speed;
variable pump displacement;
variable pump flow rate;
fluid pressure;
actuator load; and
actuator rate of change of displacement; and
varying prime mover output speed or variable pump displacement, such that the value of determined instantaneous power usage does not exceed a pre-determined limit.

19. The method of claim 15, wherein the actuator is operable to deliver:
a range of values of first force and second force, the range of values of the first force being greater than the range of values of second force; and
a range of values of first rate of change of displacement and second rate of change of displacement, the range of values of the first rate of change of displacement being lower than the range of values of second rate of change of displacement.

20. The method of claim 15, wherein the hydraulic system is in fluid communication with only one actuator.
